(19) United States
(12) Patent Application Publication
(10) Pub. No.: US 2025/0139928 A1
(43) Pub. Date: May 1, 2025

(54) IMAGE PROCESSING DEVICE AND METHOD USING REGION OF INTEREST DETECTION AND TRACKING

(71) Applicant: AY Innovative Co. Ltd., Seoul (KR)

(72) Inventor: No Gan IM, Incheon (KR)

(73) Assignee: AY Innovative Co. Ltd., Seoul (KR)

(21) Appl. No.: 18/921,070

(22) Filed: Oct. 21, 2024

(30) Foreign Application Priority Data
Oct. 30, 2023 (KR) 10-2023-0146387

(51) Int. Cl. G06V 10/25; G06T 7/215

(52) U.S. Cl. CPC G06V 10/25; G06T 7/215; G06T 2207/10016

(57) ABSTRACT

The present disclosure provides an image processing device and method using region of interest detection and tracking, wherein the image processing device using region of interest detection and tracking, including an interest region detection unit that detects at least one region of interest (ROI) from multiple detection frames of a video using artificial intelligence; an interest region motion vector estimation unit that estimates an inter-frame interest region motion vector from at least one estimation frame located between neighboring detection frames having the detected region of interest; and an interest region tracking unit that tracks the region of interest in the estimation frame using the interest region motion vector. According to the present disclosure, the region of interest is detected using artificial intelligence intermittently rather than in each of all frames, thereby drastically reducing the amount of computation, and enabling real-time image blind processing and enabling implementation in an edge computer.

### CROSS-REFERENCE TO RELATED APPLICATION

This application is based on and claims priority under 35 U.S.C. § 119 to Korean Patent Application No. 10-2023-0146387, filed on Oct. 30, 2023, in the Korean Intellectual Property Office, the disclosure of which is incorporated by reference herein in its entirety.

### BACKGROUND

One or more embodiments relate to an image processing field, and more particularly, to an image processing device and a method using region of interest detection and tracking.

To protect an individual's privacy in video such as CCTV or black box, blind processing such as blurring or mosaic-processing is applied to a region such as a face region or a license plate.

However, there is a problem that using artificial intelligence to detect regions of interest (faces, license plates) in all video frames for blind processing of personal information regions in the video requires a lot of the amount of computation and time, making real-time processing or processing on edge computers difficult.

(Patent Document 1) Korean Patent Application Laid-Open No. 10-2018-0092495 (Aug. 20, 2018)

### SUMMARY

The present disclosure is intended to solve the above problems, and provides an image processing device and a method using a region of interest detection in some frames and a region of interest estimation and tracking between frames in which the region of interest is detected.

The present disclosure provides an image processing device and a method that perform obfuscation processing, such as blind processing, of the region of interest in each frame by using estimation and tracking of the region of interest including privacy information in a video.

The tasks of the present disclosure are not limited to the tasks mentioned above, and other tasks not mentioned will be clearly understood by those skilled in the art from the description below.

An image processing device using region of interest detection and tracking according to one embodiment of the present disclosure, including an interest region detection unit that detects at least one region of interest (ROI) from multiple detection frames of a video using artificial intelligence; an interest region motion vector estimation unit that estimates an inter-frame interest region motion vector from at least one estimation frame located between neighboring detection frames having the detected region of interest; and an interest region tracking unit that tracks the region of interest in the estimation frame using the interest region motion vector.

Preferably, the region of interest detected in the detection frame is a bounding box when detecting an object using the artificial intelligence.

Preferably, the number of estimation frames located between the neighboring detection frames is determined inversely proportional to a size of the interest region motion vector.

Preferably, the image processing device using region of interest detection and tracking, further includes an object detection unit that detects an object within the region of interest in each of the detection frame and the estimation frame; and an obfuscation unit that obfuscates the object within the region of interest.

Preferably, the objects within the regions of interest in the detection frame and the estimation frame include user privacy information.

Preferably, the image processing device is implemented in an edge computer.

An image processing method using region of interest detection and tracking according to another embodiment of the present disclosure, including a step of detecting a region of interest that detects at least one region of interest (ROI) from multiple detection frames of a video using artificial intelligence by an interest region detection unit; a step of estimating an interest region motion vector that estimates an inter-frame interest region motion vector from at least one estimation frame located between neighboring detection frames having the region of interest detected by an interest region motion vector estimation unit; and a step of tracking the region of interest that tracks the region of interest in the estimation frame using the interest region motion vector by an interest region tracking unit.

Preferably, the region of interest detected in the detection frame is a bounding box when detecting an object using the artificial intelligence.

Preferably, the number of estimation frames located between the neighboring detection frames is determined inversely proportional to a size of the interest region motion vector.

Preferably, the image processing method using region of interest detection and tracking, further includes a step of detecting an object that detects an object within the region of interest in each of the detection frame and the estimation frame by an object detection unit; and a step of obfuscating that obfuscates the object within the region of interest by an obfuscation unit.

Preferably, the objects within the regions of interest in the detection frame and the estimation frame include user privacy information.

Preferably, the image processing device is implemented in an edge computer.

Specific details of other embodiments are included in the detailed description and drawings.

According to the image processing device and method using region of interest detection and tracking of the present disclosure, the region of interest is detected using artificial intelligence intermittently rather than in each of all frames, thereby drastically reducing the amount of computation, and enabling real-time image blind processing and enabling implementation in an edge computer.

However, the effects of the present disclosure are not limited to the effect mentioned above, and other effects not mentioned will be clearly understood by those skilled in the art from the description below.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram schematically illustrating a configuration of an image processing device using region of interest detection and tracking according to one embodiment of the present disclosure;

FIG. 2 is a diagram illustrating an object detection unit and an obfuscation unit of an image processing device using region of interest detection and tracking according to one embodiment of the present disclosure;

FIG. 3 is a diagram illustrating a relationship between a detection frame and estimation frames between detection frames of an image processing device using region of interest detection and tracking according to one embodiment of the present disclosure;

FIG. 4 is a diagram illustrating an operation in the detection frame and the estimation frame of FIG. 3;

FIG. 5 is a flowchart illustrating a method of preventing video forgery using a hash function according to one embodiment of the present disclosure; and

FIG. 6 is a diagram illustrating an exemplary computing device that may implement devices and/or systems according to various embodiments of the present disclosure.

### DETAILED DESCRIPTION

The advantages and features of the present disclosure, and the methods for achieving them, will become clearer with reference to the embodiments described in detail below together with the accompanying drawings. However, the present disclosure is not limited to the embodiments disclosed below, but may be implemented in various different forms, and the present embodiments are provided only to make the disclosure thereof complete and to fully inform those skilled in the art of the scope of the present disclosure, and the present disclosure is defined only by the scope of the claims. Like reference numerals refer to like elements throughout the specification.

The embodiments described herein will be described with reference to sectional and/or plan views, which are ideal illustrations of the present disclosure. In the drawings, the thicknesses of the components are exaggerated for the purpose of effectively explaining the technical contents. Accordingly, the components illustrated in the drawings have a schematic nature, and the shapes of the components illustrated in the drawings are intended to illustrate specific forms of the components and are not intended to limit the scope of the invention. Although the terms first, second, third, etc. have been used to describe various components in various embodiments of the present specification, these components should not be limited by these terms. These terms are only used to distinguish one component from another. The embodiments described and illustrated herein also include complementary embodiments thereof.

The terminology used herein is for the purpose of describing embodiments only and is not intended to be limiting of the present disclosure. In this specification, the singular also includes the plural unless the context clearly dictates otherwise. The terms “comprises” and/or “comprising” as used herein do not exclude the presence or addition of one or more other components, steps, operations, and/or elements to the mentioned components, steps, operations, and/or elements.

Unless otherwise defined, all terms (including technical and scientific terms) used in this specification may be used in a meaning that may be commonly understood by a person of ordinary skill in the art to which the present disclosure belongs. In addition, terms defined in commonly used dictionaries shall not be ideally or excessively interpreted unless explicitly specifically defined.

Hereinafter, with reference to the drawings, the concept of the present disclosure and embodiments thereof will be described in detail.

In CCTV or black box video, personal faces, license plates, etc. are private parts of an individual, so it is common to blur or mosaic blind the face regions, license plates, etc. to protect the individual's privacy.

However, in such blind processing, artificial intelligence must be applied to find the region of interest (face and license plate) for all video frames, so there is a problem that a lot of resources are consumed and the amount of computation of the resources becomes too large.

The present disclosure is intended to solve such problems and provides an image processing device that performs blind processing, etc. using a method of estimating motion between frames and tracking a region of interest.

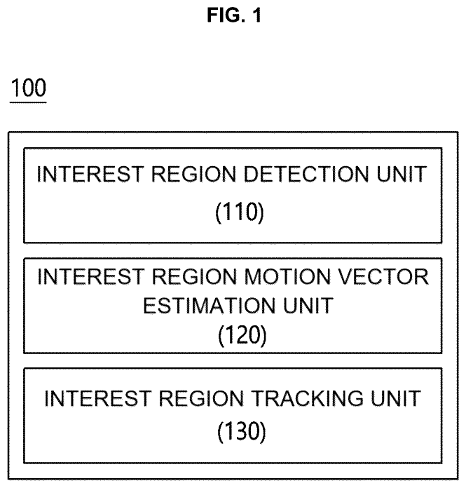

FIG. 1 is a diagram schematically illustrating a configuration of an image processing device 100 using region of interest detection and tracking according to one embodiment of the present disclosure.

The image processing device 100 using region of interest detection and tracking according to one embodiment of the present disclosure includes an interest region detection unit 110, an interest region motion vector estimation unit 120, and an interest region tracking unit 130.

The interest region detection unit 110 detects at least one region of interest (ROI) from multiple detection frames of a video using artificial intelligence.

The term “detection frame” used in the present disclosure refers to a frame in which a region of interest is detected using artificial intelligence among multiple frames of a video.

The term “estimation frame” used in the present disclosure is a concept contrasting to the detection frame, and refers to a frame in which a region of interest is estimated and tracked using an interest region motion vector between frames without using artificial intelligence.

The present disclosure is characterized by drastically reducing the amount of computation of the image processing device 100 by intermittently detecting the region of interest in detection frames and estimating and tracking the region of interest in the remaining estimation frames, rather than detecting the region of interest using artificial intelligence in all frames of the video.

In one embodiment, the region of interest detected in the detection frame is a bounding box when detecting an object using artificial intelligence.

In one embodiment of the present disclosure, the detection of the region of interest using artificial intelligence is performed using object detection technology. Object detection in still videos or videos is one of the basic and widely used technologies in the fields of video processing and computer vision.

In object detection algorithms, a main object is detected and the bounding box is displayed and distinguished around the main object.

As an example, the object detection algorithm that may be used in the present disclosure may utilize an object recognition algorithm based on deep learning that applies a convolutional neural network (CNN) or a YOLO (You Only Look Once) series algorithm.

The interest region motion vector estimation unit 120 estimates an inter-frame interest region motion vector from at least one estimation frame located between neighboring detection frames having the detected region of interest.

The interest region tracking unit 130 tracks the region of interest in the estimation frame using the interest region motion vector.

In one embodiment, the number of estimation frames located between neighboring detection frames is determined inversely proportional to the size of the interest region motion vector.

If the size of the interest region motion vector is large, it means that the motion of the region of interest within the video is large, so the accuracy of the estimation of the region of interest decreases, and therefore the number of estimation frames between detection frames is reduced.

Conversely, if the size of the interest region motion vector is small, the detection of the region of interest using artificial intelligence in the detection frames does not need to be frequent, and therefore, the number of estimation frames located between the detection frames increases relatively.

In one embodiment, the number of estimation frames located between neighboring detection frames may be adaptively determined experimentally.

In one embodiment, objects within the region of interest in the detection frame and the estimation frame are characterized by including user privacy information.

In the present disclosure, the privacy information refers to personal information such as a person's face, address, vehicle license plate number, password, or bankbook number in the video.

In one embodiment, the image processing device is characterized by being implemented in an edge computer. The image processing device 100 of the present disclosure detects the region of interest in the detection frame using artificial intelligence intermittently rather than in each of all frames, and estimates the region of interest in the remaining estimation frames, thereby drastically reducing the amount of computation, and enabling real-time image blind processing and enabling implementation in an edge computer.

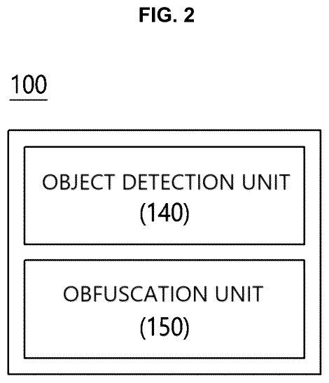

FIG. 2 is a diagram illustrating an object detection unit and the obfuscation unit of an image processing device using region of interest detection and tracking according to one embodiment of the present disclosure.

The image processing device 100 using region of interest detection and tracking further includes an object detection unit 140 that detects an object within the region of interest in each of the detection frame and the estimation frame, and an obfuscation unit 150 that obfuscates the object within the region of interest.

As used herein, the term “obfuscation” means any type of image processing that renders privacy information unrecognizable. It is a concept corresponding to code obfuscation, which is a task of making code written in a programming language difficult to read, and obfuscation in videos includes mosaic processing, blind processing, or blurring, which renders all or part of the video unrecognizable.

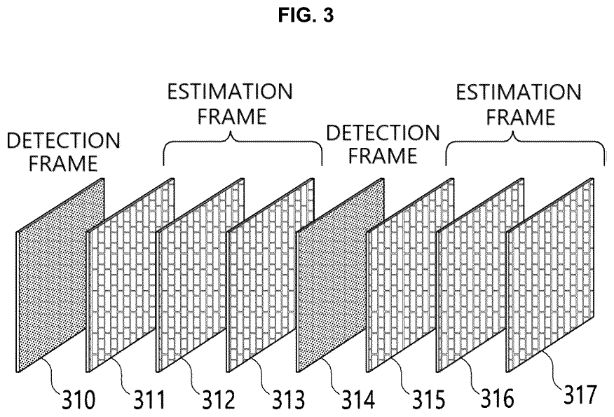

FIG. 3 is a diagram illustrating a relationship between the detection frame and the estimation frames between the detection frames of the image processing device using region of interest detection and tracking according to one embodiment of the present disclosure.

As illustrated in FIG. 3, there are three estimation frames 311, 312, and 313 between neighboring detection frames 310 and 314.

Although three estimation frames are illustrated to exist between the neighboring detection frames 310 and 314 in FIG. 3, this is only an example, and the number of estimation frames is variable depending on the size of the interest region motion vector between frames.

Detection of the region of interest in the detection frame 310 and the detection frame 314 is performed using artificial intelligence, and estimation of the region of interest in the estimation frames 311, 312, and 313 is not performed directly using artificial intelligence, but is performed using the size of the interest region motion vector between frames.

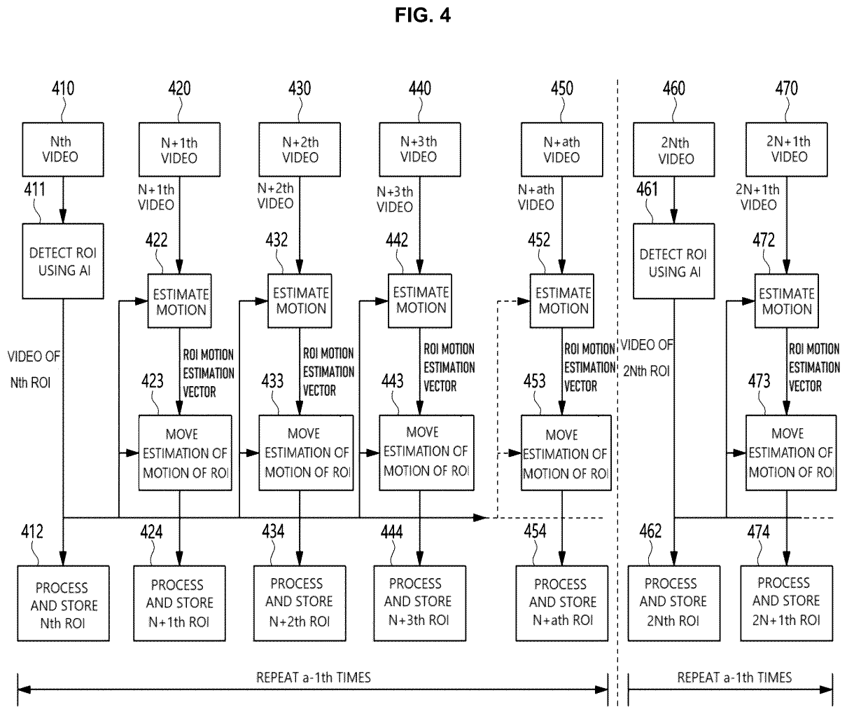

FIG. 4 is a diagram illustrating an operation in the detection frame and the estimation frame of FIG. 3.

Referring to FIG. 4, the Nth video frame 410 detects the region of interest using artificial intelligence (411). The Nth video frame 410 is a detection frame because it detects the region of interest using artificial intelligence.

The image processing device 100 of the present disclosure may detect the region of interest, perform obfuscation processing, and store it in a storage medium (412).

The N+1^{th} video frame 420 estimates the motion of the region of interest using the interest region motion vector without using artificial intelligence (423).

The interest region motion vector estimation unit 120 estimates the motion using the motion of the Nth region of interest in the N+1^{th} video frame 420 (422), and estimates the motion of the region of interest using the estimated interest region motion vector (423).

In the N+1^{th} video frame 420, motion estimation of the region of interest is performed relative to the region of interest detected in the Nth video frame 410.

Then, the estimated region of interest is performed of obfuscation processing and stored in the storage medium (424).

The N+2^{th} video frame 430, the N+3^{th} video frame 440, and the N+ath video frame 450 are estimated frames in which the motion of the region of interest is estimated using the estimated interest region motion vector without using artificial intelligence.

The motion estimation, tracking, and obfuscation processing of the region of interest in the N+2^{th} video frame 430, the N+3^{th} video frame 440, and the N+ath video frame 450 are similar to the processing in the N+1^{th} video frame 420.

As illustrated in FIG. 4, the 2Nth video frame 460 detects the region of interest using artificial intelligence (461). The 2Nth video frame 460, like the Nth video frame 410, is a detection frame because it detects the region of interest using artificial intelligence.

Accordingly, the image processing device 100 of the present disclosure may detect the region of interest of the 2Nth video frame 460, perform obfuscation processing, and store it in the storage medium (462).

The 2N+1^{th} video frame 470 estimates the motion of the region of interest using the interest region motion vector without using artificial intelligence (473).

The interest region motion vector estimation unit 120 estimates the motion of the region of interest in the 2N+1^{th} video frame 470 (472) and estimates the motion of the region of interest using the interest region motion vector (473).

In the 2N+1^{th} video frame 470, motion estimation of the region of interest is performed relative to the region of interest detected in the Nth video frame 460.

Then, the estimated region of interest is performed of obfuscation processing and stored in the storage medium (424).

As described above, the number of estimation frames located between the detection frames is determined inversely proportional to the size of the interest region motion vector. Therefore, the number of estimation frames varies adaptively.

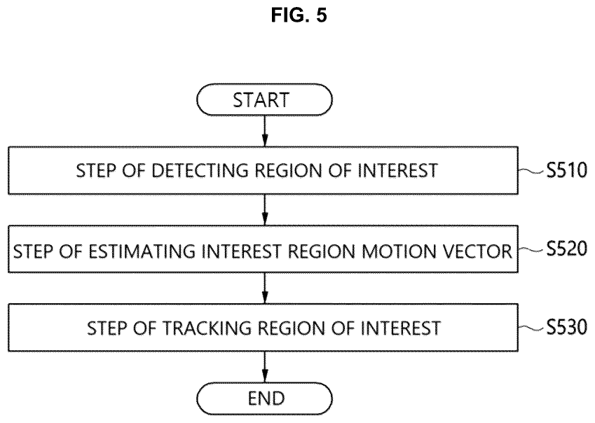

FIG. 5 is a flowchart illustrating a method of preventing video forgery using a hash function according to one embodiment of the present disclosure.

An image processing method using region of interest detection and tracking according to another embodiment of the present disclosure includes a step of detecting the region of interest (S510), a step of estimating the interest region motion vector (S520), and a step of tracking the region of interest (530).

The step of detecting the region of interest (S510) detects at least one region of interest (ROI) from multiple detection frames of the video using artificial intelligence by the interest region detection unit 110.

The step of estimating the interest region motion vector (S520) estimates the inter-frame interest region motion vector from at least one estimation frame located between neighboring detection frames having the region of interest detected by the interest region motion vector estimation unit 120.

The step of tracking the region of interest (530) tracks the region of interest in the estimation frame using the interest region motion vector by the interest region tracking unit 130.

In one embodiment, the region of interest detected in the detection frame is characterized as a bounding box when detecting the object using artificial intelligence.

In one embodiment, the number of estimation frames located between neighboring detection frames is characterized in that it is determined inversely proportional to the size of the interest region motion vector.

In one embodiment, the image processing method using region of interest detection and tracking of the present disclosure further includes a step of detecting an object that detects an object within the region of interest in each of the detection frame and the estimation frame by the object detection unit 140; and a step of obfuscating that obfuscates the object within the region of interest by the obfuscation unit 150.

In one embodiment, the objects within the regions of interest in the detection frame and the estimation frame include user privacy information.

In one embodiment, the image processing device may be implemented in an edge computer.

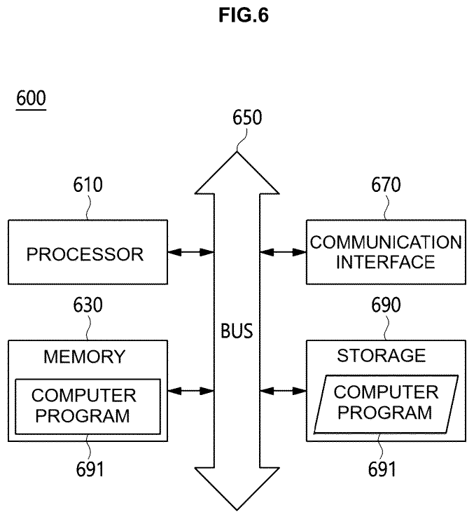

FIG. 6 is a diagram illustrating an exemplary computing device that may implement devices and/or systems according to various embodiments of the present disclosure.

An exemplary computing device 600 that may implement devices according to some embodiments of the present disclosure will be described in more detail with reference to FIG. 6.

The computing device 600 may include one or more processors 610, a bus 650, a communication interface 670, a memory 630 for loading a computer program 691 executed by the processor 610, and a storage 690 for storing the computer program 691. However, only components related to the embodiment of the present disclosure are illustrated in FIG. 6.

Accordingly, a person skilled in the art will appreciate that the present disclosure may further include general components other than those illustrated in FIG. 6.

The processor 610 controls the overall operation of each component of the computing device 600. The processor 610 may be configured to include a CPU (Central Processing Unit), an MPU (Micro Processor Unit), an MCU (Micro Controller Unit), a GPU (Graphics Processing Unit), or any other form of processor 610 well known in the art of the present disclosure. In addition, the processor 610 may perform operations for at least one application or program for executing a method according to embodiments of the present disclosure. The computing device 600 may have one or more processors 610. The computing device 600 may refer to artificial intelligence (AI).

The memory 630 stores various data, commands, and/or information. The memory 630 may load one or more programs 691 from the storage 690 to execute a method according to embodiments of the present disclosure. The memory 630 may be implemented as a volatile memory such as RAM, but the technical scope of the present disclosure is not limited thereto.

The bus 650 provides a communication function between components of the computing device 600. The bus 650 may be implemented as various types of buses such as an address bus, a data bus, and a control bus.

The communication interface 670 supports wired and wireless Internet communication of the computing device 600. In addition, the communication interface 670 may support various communication methods other than Internet communication. To this end, the communication interface 670 may be configured to include a communication module well known in the technical field of the present disclosure.

According to some embodiments, the communication interface 670 may be omitted.

Storage 690 may non-temporarily store one or more programs 691 and various data.

The storage 690 may be configured to include a nonvolatile memory such as a ROM (Read Only Memory), an EPROM (Erasable Programmable ROM), an EEPROM (Electrically Erasable Programmable ROM), and a flash memory, a hard disk, a removable disk, or any form of computer-readable recording medium well known in the art to which the present disclosure pertains.

The computer program 691 may include one or more instructions that cause the processor 610 to perform methods/operations according to various embodiments of the present disclosure when loaded into the memory 630. That is, the processor 610 may perform the methods/operations according to various embodiments of the present disclosure by executing the one or more instructions.

Although the preferred embodiments of the present disclosure have been illustrated and described above, the present disclosure is not limited to the specific embodiments described above, and various modifications may be made by those skilled in the art without departing from the gist of the present disclosure as claimed in the claims. Furthermore, such modifications should not be understood individually from the technical idea or prospect of the present disclosure.

What is claimed is:

1. An image processing device using region of interest detection and tracking, comprising:
an interest region detection unit that detects at least one region of interest (ROI) from multiple detection frames of a video using artificial intelligence;
an interest region motion vector estimation unit that estimates an inter-frame interest region motion vector from at least one estimation frame located between neighboring detection frames having the detected region of interest; and
an interest region tracking unit that tracks the region of interest in the estimation frame using the interest region motion vector.

2. The image processing device using region of interest detection and tracking according to claim 1, wherein
the region of interest detected in the detection frame is a bounding box when detecting an object using the artificial intelligence.

3. The image processing device using region of interest detection and tracking according to claim 1, wherein
the number of estimation frames located between the neighboring detection frames is determined inversely proportional to a size of the interest region motion vector.

4. The image processing device using region of interest detection and tracking according to claim 1, further comprising:
an object detection unit that detects an object within the region of interest in each of the detection frame and the estimation frame; and
an obfuscation unit that obfuscates the object within the region of interest.

5. The image processing device using region of interest detection and tracking according to claim 4, wherein
the objects within the regions of interest in the detection frame and the estimation frame include user privacy information.

6. The image processing device using region of interest detection and tracking according to claim 1, wherein
the image processing device is implemented in an edge computer.

7. An image processing method using region of interest detection and tracking, comprising:
a step of detecting a region of interest that detects at least one region of interest (ROI) from multiple detection frames of a video using artificial intelligence by an interest region detection unit;
a step of estimating an interest region motion vector that estimates an inter-frame interest region motion vector from at least one estimation frame located between neighboring detection frames having the region of interest detected by an interest region motion vector estimation unit; and
a step of tracking the region of interest that tracks the region of interest in the estimation frame using the interest region motion vector by an interest region tracking unit.

8. The image processing method using region of interest detection and tracking according to claim 7, wherein
the region of interest detected in the detection frame is a bounding box when detecting an object using the artificial intelligence.

9. The image processing method using region of interest detection and tracking according to claim 7, wherein
the number of estimation frames located between the neighboring detection frames is determined inversely proportional to a size of the interest region motion vector.

10. The image processing method using region of interest detection and tracking according to claim 7, further comprising:
a step of detecting an object that detects an object within the region of interest in each of the detection frame and the estimation frame by an object detection unit; and
a step of obfuscating that obfuscates the object within the region of interest by an obfuscation unit.

11. The image processing method using region of interest detection and tracking according to claim 10, wherein
the objects within the regions of interest in the detection frame and the estimation frame include user privacy information.

12. The image processing method using region of interest detection and tracking according to claim 7, wherein
the image processing device is implemented in an edge computer.
